(19) United States
(12) Patent Application Publication
(10) Pub. No.: US 2025/0226862 A1
(43) Pub. Date: Jul. 10, 2025

(54) BEAM SQUINT AND LOCATION-UNCERTAINTY AWARE DESIGNS

(71) Applicant: QUALCOMM Incorporated, San Diego, CA (US)

(72) Inventors: Narayan PRASAD, Westfield, NJ (US); Tao LUO, San Diego, CA (US); Mohammad Ali TASSOUDJI, San Diego, CA (US); Ahmed BEDEWY, Hillsborough, NJ (US); Juergen CEZANNE, Ocean Township, NJ (US); Meilong JIANG, Westfield, NJ (US); Junyi LI, Fairless Hills, PA (US)

(21) Appl. No.: 18/409,558

(22) Filed: Jan. 10, 2024

(51) Int. Cl. H04B 7/06; H04B 7/04

(52) U.S. Cl. CPC H04B 7/0617; H04B 7/04013

(57) ABSTRACT

Methods, systems, and devices for wireless communications are described. A network entity may output an array configuration to a configurable reflective device (CRD), wherein the array configuration defines a first angle of reflection or refraction at a first frequency and a second angle of reflection or refraction at a second frequency for a reflective array of the CRD. The network entity may output a first transmission, to a first user equipment (UE) via the CRD, at the first frequency according to the array configuration, the first frequency selected based on the first angle of reflection or refraction and a first location of the first UE. The network entity may output a second transmission, to a second UE via the CRD, at the second frequency according to the array configuration, the second frequency selected based on the second angle of reflection or refraction and a second location of the second UE.

### FIELD OF TECHNOLOGY

The following relates to wireless communications, including beam squint and location-uncertainty aware designs.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support beam squint and location-uncertainty aware designs. For example, the described techniques provide for utilization of a squint effect of the reconfigurable intelligent surface (RIS) (e.g., a reconfigurable reflective/refractive entity) to support multi-user equipment (UE) communications using the same array configuration. For example, the squint effect of the RIS may be leveraged to support simultaneous wireless transmissions to different UE at different locations where the frequency used for each UE is selected based on the location of the UE and the angle of reflection or refraction associated with the array configuration. For example, a network entity may transmit or otherwise provide for output an array configuration to a RIS. The array configuration may leverage the squint effect to provide for a first angle reflection or refraction at a first frequency (e.g., towards a first UE) and a second angle of reflection or refraction at a second frequency (e.g., towards a second UE). The network entity may transmit or otherwise provide for output a first transmission to the first UE via the RIS using the first frequency. The network entity may transmit or otherwise provide for output a second transmission to the second UE via the RIS using the second frequency. The first frequency may be based on the location of the first UE (e.g., relative to the RIS) and the first angle of reflection or refraction. The second frequency may be based on the location of the second UE (e.g., relative to the RIS) and the second angle of reflection or refraction. Accordingly, the network entity may configure the RIS to leverage the squinting effect to direct transmissions to multiple UEs using the reflection/refraction angles associated with each frequency.

A method for wireless communications by a network entity is described. The method may include outputting an array configuration to a configurable reflective device, where the array configuration defines a first angle of reflection or refraction at a first frequency and a second angle of reflection or refraction at a second frequency for a reflective array of the configurable reflective device, outputting a first transmission, to a first user equipment (UE) via the configurable reflective device, at the first frequency according to the array configuration, the first frequency selected based on the first angle of reflection or refraction and a first location of the first UE, and outputting a second transmission, to a second UE via the configurable reflective device, at the second frequency according to the array configuration, the second frequency selected based on the second angle of reflection or refraction and a second location of the second UE.

A network entity for wireless communications is described. The network entity may include one or more memories storing processor executable code, and one or more processors coupled with the one or more memories. The one or more processors may individually or collectively operable to execute the code to cause the network entity to output an array configuration to a configurable reflective device, where the array configuration defines a first angle of reflection or refraction at a first frequency and a second angle of reflection or refraction at a second frequency for a reflective array of the configurable reflective device, output a first transmission, to a first UE via the configurable reflective device, at the first frequency according to the array configuration, the first frequency selected based on the first angle of reflection or refraction and a first location of the first UE, and output a second transmission, to a second UE via the configurable reflective device, at the second frequency according to the array configuration, the second frequency selected based on the second angle of reflection or refraction and a second location of the second UE.

Another network entity for wireless communications is described. The network entity may include means for outputting an array configuration to a configurable reflective device, where the array configuration defines a first angle of reflection or refraction at a first frequency and a second angle of reflection or refraction at a second frequency for a reflective array of the configurable reflective device, means for outputting a first transmission, to a first UE via the configurable reflective device, at the first frequency according to the array configuration, the first frequency selected based on the first angle of reflection or refraction and a first location of the first UE, and means for outputting a second transmission, to a second UE via the configurable reflective device, at the second frequency according to the array configuration, the second frequency selected based on the second angle of reflection or refraction and a second location of the second UE.

A non-transitory computer-readable medium storing code for wireless communications is described. The code may include instructions executable by one or more processors to output an array configuration to a configurable reflective device, where the array configuration defines a first angle of reflection or refraction at a first frequency and a second angle of reflection or refraction at a second frequency for a reflective array of the configurable reflective device, output a first transmission, to a first UE via the configurable reflective device, at the first frequency according to the array configuration, the first frequency selected based on the first angle of reflection or refraction and a first location of the first UE, and output a second transmission, to a second UE via the configurable reflective device, at the second frequency according to the array configuration, the second frequency selected based on the second angle of reflection or refraction and a second location of the second UE.

Some examples of the method, network entities, and non-transitory computer-readable medium described herein may further include operations, features, means, or instructions for selecting the first UE for communicating the first transmission at the first frequency based on the first location of the first UE relative to the configurable reflective device and selecting the second UE for communicating the second transmission at the second frequency based on the second location of the second UE relative to the configurable reflective device.

Some examples of the method, network entities, and non-transitory computer-readable medium described herein may further include operations, features, means, or instructions for selecting the first UE for communicating the first transmission at the first frequency based on the first angle of reflection or refraction of the first UE relative to the configurable reflective device and selecting the second UE for communicating the second transmission at the second frequency based on the second angle of reflection or refraction of the second UE relative to the configurable reflective device.

Some examples of the method, network entities, and non-transitory computer-readable medium described herein may further include operations, features, means, or instructions for selecting the first frequency for communicating the first transmission to the first UE based on the first location of the first UE relative to the configurable reflective device and selecting the second frequency for communicating the second transmission to the second UE based on the second location of the second UE relative to the configurable reflective device.

Some examples of the method, network entities, and non-transitory computer-readable medium described herein may further include operations, features, means, or instructions for selecting the array configuration based on the first location of the first UE relative to the configurable reflective device, on the first angle of reflection or refraction, on the second location of the second UE relative to the configurable reflective device, on the second angle of reflection or refraction, or any combination thereof.

Some examples of the method, network entities, and non-transitory computer-readable medium described herein may further include operations, features, means, or instructions for performing a set of pilot transmissions via the configurable reflective device using a set of available array configurations and at different frequencies, obtaining, based on the set of pilot transmissions, a first feedback report from the first UE indicating the array configuration, the first frequency, the first angle of reflection or refraction, a first measurement value associated with the array configuration and the first frequency, or any combination thereof, and obtaining, based on the set of pilot transmissions, a second feedback report from the second UE indicating the array configuration, the second frequency, the second angle of reflection angle, a second measurement value associated with the array configuration and the second frequency, or any combination thereof.

In some examples of the method, network entities, and non-transitory computer-readable medium described herein, performing the set of pilot transmissions may include operations, features, means, or instructions for outputting, iteratively for each available array configuration in the set of available array configurations, each available array configuration in the set of available array configurations and outputting, during each iteration, the set of pilot transmissions using each available array configuration at the different frequencies.

Some examples of the method, network entities, and non-transitory computer-readable medium described herein may further include operations, features, means, or instructions for outputting an indication of the first feedback report, the second feedback report, or both and obtaining, based on the indication, an indication of the array configuration based on the first feedback report, the second feedback report, and a location of the configurable reflective device relative to the first UE and the second UE.

In some examples of the method, network entities, and non-transitory computer-readable medium described herein, selection of the first location of the first UE, the second location of the second UE, or both, may be based on the set of pilot transmissions, the first feedback report, the second feedback report, or any combination thereof.

In some examples of the method, network entities, and non-transitory computer-readable medium described herein, selection of the first frequency for the first transmission to the first UE, the second frequency for the second transmission to the second UE, or both, may be based on the set of pilot transmissions, the first feedback report, the second feedback report, or any combination thereof.

In some examples of the method, network entities, and non-transitory computer-readable medium described herein, selection the first angle of reflection or refraction at the first frequency, the second angle of reflection or refraction at the second frequency, or both, may be based on the set of pilot transmissions, the first feedback report, the second feedback report, or any combination thereof.

Some examples of the method, network entities, and non-transitory computer-readable medium described herein may further include operations, features, means, or instructions for obtaining information associated with a first uncertainty region associated with the first location of the first UE and a second uncertainty region associated with the second location of the second UE.

In some examples of the method, network entities, and non-transitory computer-readable medium described herein, selection of the first UE, the first frequency, the second UE, the second frequency, or any combination thereof, may be based on the first uncertainty region, the second uncertainty region, or both.

In some examples of the method, network entities, and non-transitory computer-readable medium described herein, selection of the array configuration may be based on the first uncertainty region, the second uncertainty region, or both.

In some examples of the method, network entities, and non-transitory computer-readable medium described herein, the first transmission to the first UE and the second transmission to the second UE include overlapping transmissions in a time domain.

### BRIEF DESCRIPTION OF THE DRAWINGS

FIG. 1 shows an example of a wireless communications system that supports beam squint and location-uncertainty aware designs in accordance with one or more aspects of the present disclosure.

FIG. 2 shows an example of a wireless communications system that supports beam squint and location-uncertainty aware designs in accordance with one or more aspects of the present disclosure.

FIG. 3 shows an example of a wireless communications system that supports beam squint and location-uncertainty aware designs in accordance with one or more aspects of the present disclosure.

FIG. 4 shows an example of a swim diagram that supports beam squint and location-uncertainty aware designs in accordance with one or more aspects of the present disclosure.

FIGS. 5 and 6 show block diagrams of devices that support beam squint and location-uncertainty aware designs in accordance with one or more aspects of the present disclosure.

FIG. 7 shows a block diagram of a communications manager that supports beam squint and location-uncertainty aware designs in accordance with one or more aspects of the present disclosure.

FIG. 8 shows a diagram of a system including a device that supports beam squint and location-uncertainty aware designs in accordance with one or more aspects of the present disclosure.

FIGS. 9 through 11 show flowcharts illustrating methods that support beam squint and location-uncertainty aware designs in accordance with one or more aspects of the present disclosure.

### DETAILED DESCRIPTION

Reconfigurable intelligent surface (RIS) entities (e.g., a reconfigurable reflective/refractive entity) may be deployed within a wireless network to improve wireless communications. The RIS is generally a passive device equipped with an array of reflective surface elements. The RIS may be a passive or active entity that is configured by an associated network entity. For example, the network entity may provide an array configuration to the RIS. The array configuration may generally define configuration or settings for an array of reflective or refractive elements of the RIS that can be dynamically programmed to control the reflection, refraction, and scattering of electromagnetic waves (e.g., wireless transmissions). However, for a given array configuration the magnitude of the reflected or refracted wireless transmission at any given angle may be based on the frequency used for the wireless transmission. That is, and for the same array configuration, a first frequency may be significantly reflected or refracted at a first angle from the RIS while a second frequency may be significantly reflected or refracted at a second angle from the RIS that is different from the first angle. In this aspect, being significantly reflected or refracted may correspond to most, but not all, of the reflected or refracted wireless signal energy being reflected or refracted at an angle that is frequency dependent. This difference in angles of significant signal in reflection or refraction at different frequencies for a given array configuration is termed beam squint and in some wireless networks is considered a source of interference, performance degradation, and is to be avoided.

Aspects of the disclosure are initially described in the context of wireless communications systems. For example, the described techniques provide for utilization of a squint effect of the RIS to support multi-user equipment (UE) communications using the same array configuration. For example, the squint effect of the RIS may be leveraged to support simultaneous wireless transmissions to different UEs at different locations where the frequency used for each UE is selected based on the location of the UE and the angle of reflection or refraction associated with the array configuration. For example, a network entity may transmit or otherwise provide for output an array configuration to a RIS. The array configuration may leverage the squint effect to provide for a first angle reflection or refraction at a first frequency (e.g., towards a first UE) and a second angle of reflection or refraction at a second frequency (e.g., towards a second UE). The network entity may transmit or otherwise provide for output a first transmission to the first UE via the RIS using the first frequency. The network entity may transmit or otherwise provide for output a second transmission to the second UE via the RIS using the second frequency. The first frequency may be based on the location of the first UE (e.g., relative to the RIS) and the first angle of reflection or refraction. The second frequency may be based on the location of the second UE (e.g., relative to the RIS) and the second angle of reflection or refraction. Accordingly, the network entity may configure the RIS to leverage the squint effect to direct transmissions to multiple UEs using the reflection/refraction angles associated with each frequency.

Aspects of the disclosure are further illustrated by and described with reference to apparatus diagrams, system diagrams, and flowcharts that relate to beam squint and location-uncertainty aware designs.

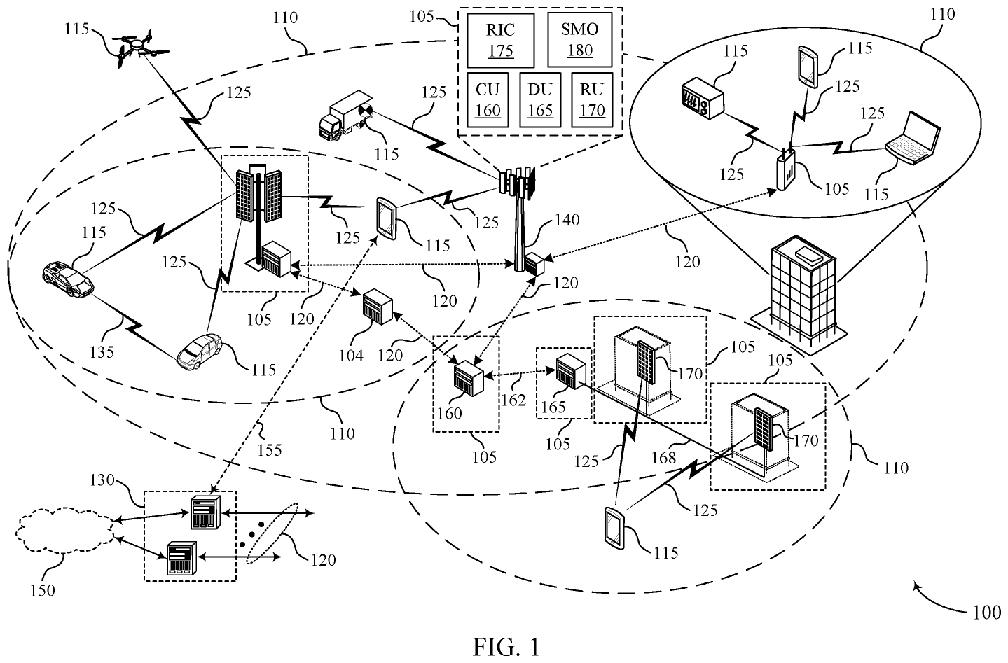

FIG. 1 shows an example of a wireless communications system 100 that supports beam squint and location-uncertainty aware designs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support beam squint and location-uncertainty aware designs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A network entity 105 may output an array configuration to a configurable reflective device, wherein the array configuration defines a first angle of reflection or refraction at a first frequency and a second angle of reflection or refraction at a second frequency for a reflective array of the configurable reflective device. The network entity 105 may output a first transmission, to a first UE via the configurable reflective device, at the first frequency according to the array configuration. The first frequency may be selected based at least in part on the first angle of reflection or refraction and a first location of the first UE. The network entity 105 may output a second transmission, to a second UE via the configurable reflective device, at the second frequency according to the array configuration. The second frequency may be selected based at least in part on the second angle of reflection or refraction and a second location of the second UE. It is to be understood that a configurable reflective device denotes an entity that is capable of reflection or refraction, where the reflection or refraction are configurable.

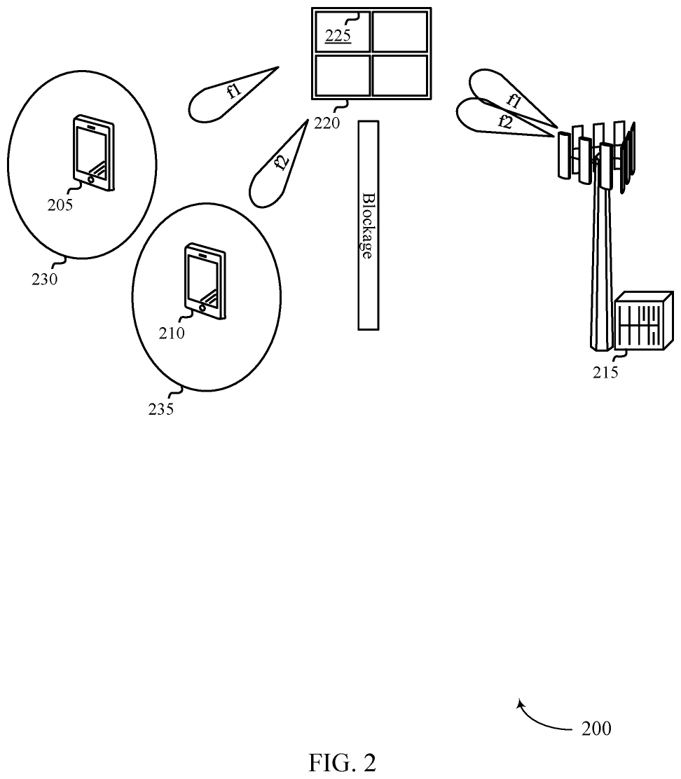

FIG. 2 shows an example of a wireless communications system 200 that supports beam squint and location-uncertainty aware designs in accordance with one or more aspects of the present disclosure. Wireless communications system 200 may implement aspects of wireless communications system 100. Wireless communications system 200 may include a UE 205, a UE 210, a network entity 215, and a RIS 220, which may be examples of the corresponding devices or entities described herein.

The wireless communications system 200 may include a configurable reflective device, that may also be referred to as a RIS (e.g., the RIS 220). The configurable reflective device may be deployed within a wireless network to extend the coverage area of a transmitting device (e.g., around a blockage), with negligible power consumption. The configurable reflective device may be an active or a near passive entity including a set of one or more reflective arrays (with four reflective array(s) 225 being shown by way of non-limiting example only). Each, some, or all reflective array(s) 225 may include individual reflective or refractive elements and may generally be operable or otherwise configured to reflect or refract an impinging wave to a desired direction. The RIS 220 may include a receiver enabling the network entity 215 to control the reflection/refraction direction of each or every reflective array(s) 225. For example, the network entity 215 may transmit or otherwise provide for output control signaling to the RIS 220 indicating how each reflective array(s) 225 is to be configured (e.g., an array configuration). Accordingly, the RIS 220 may include an array of reflective or refractive elements that can be dynamically programmed to control the reflection and scattering of electromagnetic waves. Configuration of the RIS 220 (e.g., the array configuration, which may include various weighting vectors) may be controlled via control inputs in a wideband frequency non-selective manner that can be switched or otherwise updated in time.

That is, devices such as the UE 205, the UE 210, and the network entity 215 may leverage established communication links with the RIS 220 that is coupled with or otherwise able to control the configuration of the reflective or refractive surface (e.g., reflective array(s) 225) to establish a communication link between the devices via the reflective surface. For example, the network entity 215 (e.g., via the RIS 220) may establish a communication link with each of two devices via respective beam training procedures and network entity 215 may use information, such as beam directions or other channel characteristics, associated with directional beams that the RIS 220 uses for communication with the two devices, as well as information associated with which of the two devices is transmitting to the other, to control a reflection or refraction characteristic of the reflective surface. It is to be understood that the reflective surface is capable of reflection or refraction. In other words, the network entity 215 and the RIS 220 may use information associated with a direction of signaling, such as a direction of signal reception (such as a receive beam direction) and/or a direction of signal transmission (such as a transmit beam direction) to determine or otherwise infer a direction of incident signaling at the reflective surface and a direction for reflected/refracted signaling from the reflective surface. The RIS 220, accordingly, may control the reflection/refraction characteristics of the reflective surface in accordance with the determined or inferred directions of incident and reflected signaling and this is accomplished by way of array configuration signaling.

The RIS 220 may be associated with a phenomenon known as the beam squint effect. Beam squint generally refers to the altering of the angle of reflection or refraction of a wireless signal from a reflective element across different signal frequencies. Beam squint is a frequency-dependent effect where, as the frequency of the signal varies, the angle of significant reflection or refraction also varies. That is, as the operating frequency of the wireless signal changes, the phase shift provided by the reflective array (according to the array configuration) will result in the reflected or refracted signal being reinforced (e.g., coherently combined) in an angle (or direction) different from the original one. The amount of beam squint across two different frequencies may depend on the magnitude of the frequency difference. Beam squint is generally avoided by wireless networks in order to avoid performance degradation, interference, or other disruptions to the wireless medium.

However, aspects of the techniques described herein leverage the beam squint effect to support multi-UE wireless communications via the RIS 220. The RIS 220 configured with an optimized array configuration that creates a multi-peak reflective or refractive beam can enable simultaneous wireless communications between the transmitting device (e.g., the network entity 215) with multiple receivers (e.g., the UE 205 and the UE 210), even in the absence of a direct transmit-receive path. Aspects of the described techniques may use location or direction information of the transmitting device and each receiving device relative to the RIS 220. Further, these techniques may result in a gain reduction for each peak while maintaining reliable communications.

In particular, aspects of the described techniques may use frequency allocation that allows for wide frequency spacing among the scheduled receivers to significantly improve flexibility. This may result in the beam squint phenomenon and, in some aspects, the frequency selective response of the RIS 220 due to the frequency dependence of its component impedances.

Accordingly, aspects of the described techniques may leverage smart receiver subset selection, frequency assignment, and RIS configuration designs that exploit the beam squint effect. This technique may bridge some of the difference in the required beam-pointing directions (e.g., to minimize gain reduction). Aspects of these techniques may leverage location information, direction information, or both, when available, to optimize the beam squinting exploitation and management based on uncertainty regions (e.g., rather than dismissing such information or assuming the information to be completely accurate). The uncertainty region generally defines an area within which a given receiver or transmitter is expected to be located. For example, the UE 205 may be associated with an uncertainty region 230 and the UE 210 may be associated with an uncertainty region 235. The uncertainty region associated with each receiving device (and transmitting device, in some scenarios) may be based on at least some degree of the location or direction information of each device relative to the RIS 220.

Depending on the uncertainty region of the network entity 215 and the uncertainty regions of the UE 205 and the UE 210, and their assigned distinct frequency bands, a RIS weighting factor (e.g., an array configuration) may be selected for optimized simultaneous communication performance between the transmitter and both receivers. In some aspects, the applied RIS configuration (e.g., the array configuration) may be selected to be close to the optimized single-peak beam of the UE 205 alone at frequency f1 and may approach the optimized single-peak beam for the UE 210 alone at frequency f2 by exploiting the beam squint effect.

Accordingly, the network entity 215 may transmit or otherwise provide for output (and the RIS 220 may receive or otherwise obtain) an array configuration (e.g., the RIS configuration/weighting) that defines a first angle of reflection of refraction at a first frequency (e.g., f1) and a second angle of reflection or refraction at a second frequency (e.g., f2) for the reflective array(s) 225 of the RIS 220. The array configuration may be identified, selected, or otherwise determined based on the location or direction information (which may be based on the uncertainty regions, in some examples) of each receiver relative to the RIS 220. That is, a first receiver (e.g., the UE 205, in this example) may be associated with a first location or direction relative to the RIS 220 while the second receiver (e.g., the UE 210, in this example) may be associated with a second location or direction relative to the RIS 220. Additionally, or alternatively, the first receiver may also be associated with the first angle of reflection or refraction while the second receiver may be associated with a second angle of reflection or refraction.

That is, the array configuration may generally leverage the first angle of reflection or refraction for the UE 205 relative to the RIS 220 and the location or direction information at the frequency f1 as well as the second angle of reflection or refraction for the UE 210 relative to the RIS 220 and the location or direction information as the frequency f2 to support multi-UE communications to both UE. This may enable the network entity 215 to simultaneously (e.g., overlapping in the time domain) transmit to each receiver at different frequencies using the same array configuration.

In some aspects, the array configuration may be based on the uncertainty regions associated with each receiver and, in some instances, the transmitter. For example, the network entity 215 may receive or otherwise obtain (e.g., from a core network node, such as the access and management function (AMF) or other node) information associated with the uncertainty region 230 of the UE 205 as well as the uncertainty region 235 of the UE 210. The uncertainty region may be utilized during selection of the array configuration signaled to the RIS 220.

Leveraging the beam squint effect at the RIS 220 for a given array configuration may consider various information during scheduling. For example, the network entity 215 may use the first location of the UE 205 along with the first angle of reflection or refraction at f1 relative to the location of the RIS 220. Similarly, the network entity 215 may use the second location of the UE 210 along with the second angle of reflection or refraction at f2 relative to the location of the RIS 220. In some examples, this may include the network entity 215 selecting various of these parameters based on the related parameters.

More particularly, the network entity 215 may identify, determine, or otherwise select the first UE (e.g., the UE 205) for communications at the first frequency f1 based on the location of the UE 205 relative to the RIS 220 and the second UE (e.g., the UE 210) for communications at the second frequency f2 based on the location of the UE 210 relative to the RIS 220. That is, the network entity 215 may select which UE to be included in the multi-UE communications based on their location or direction information relative to the location of the RIS 220.

Additionally, or alternatively, the network entity 215 may identify, determine, or otherwise select the first UE (e.g., the UE 205) for communications at the first frequency f1 based on the first angle of reflection or refraction of the UE 205 relative to the RIS 220 and the second UE (e.g., the UE 210) for communications at the second frequency f2 based on the second angle of reflection or refraction of the UE 210 relative to the RIS 220. That is, the network entity 215 may select which UE to be included in the multi-UE communications based on the reflection/refraction angles from the RIS 220.

Additionally, or alternatively, the network entity 215 may identify, determine, or otherwise select the first frequency f1 for communications with the first UE (e.g., the UE 205) based on the location of the UE 205 relative to the RIS 220 and the second frequency f2 for communications with the second UE (e.g., the UE 210) based on the location of the UE 210 relative to the RIS 220. That is, the network entity 215 may select which UE to be included in the multi-UE communications based on their location or direction information relative to the location of the RIS 220.

More particularly, the network entity 215 may use the location information of each available receiver, the angles of reflection of refraction from the RIS 220 towards each available receiver, the available frequencies, or any combination of these factors, to select or otherwise identify the array configuration that will support simultaneous multi-UE communications at the different frequencies. Each factor may be considered equally or weighting factor(s) may be applied to one, some, or all factors. The location information of each receiver may be an exact location (e.g., known) or may be based on the uncertainty region (likely location) of each available receiver. A confidence level associated with each receiver location may be used for the array configuration selection.

Accordingly, the network entity 215 may configure the RIS 220 with the array configuration and then transmit or otherwise provide for output a first transmission to the first UE (e.g., the UE 205) via the RIS 220 at the first frequency f1. Again, the first frequency f1 may be based on the first angle of reflection or refraction of the wireless signal from the RIS 220 and the location information of the first UE. Simultaneously, the UE 210 may transmit or otherwise provide for output a second transmission to the second UE (e.g., the UE 210) via the RIS 220 at the second frequency f2. The second frequency f2 may be based on the second angle of reflection or refraction of the wireless signal from the RIS 220 and the location information of the second UE.

As discussed, in some examples the network entity 215 may optimize the array configuration at the first frequency f1 for communications with the first UE and then select the second UE, the second frequency f2, or both, for the simultaneous communications based on the second angle of reflection or refraction of the wireless transmission from the RIS 220 and the location of the second UE. In other examples, the network entity 215 may select the first UE and the second UE, the first frequency f1 and the second frequency f2, or both, based on the associated reflection/refraction angles and the locations of the first and second UE.

Accordingly, the techniques described herein may support joint receiver subset selection, frequency allocation, and RIS configuration designs for simultaneous frequency multiplexed transmissions between the transmitter and multiple receivers. These techniques may use accurate or approximate location/direction information, when available.

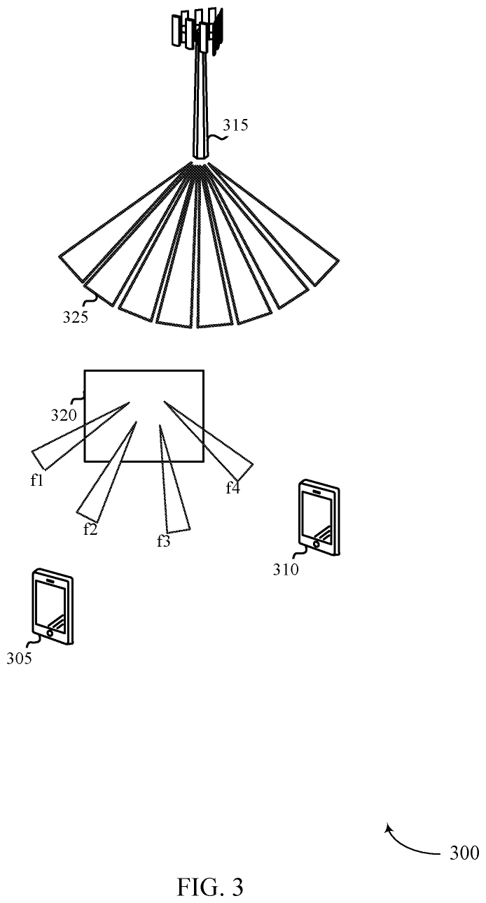

FIG. 3 shows an example of a wireless communications system 300 that supports beam squint and location-uncertainty aware designs in accordance with one or more aspects of the present disclosure. Wireless communications system 300 may implement aspects of wireless communications system 100 or wireless communications system 200. Wireless communications system 300 may include a UE 305, a UE 310, a network entity 315, and a RIS 320, which may be examples of the corresponding devices or entities described herein. For example, the RIS 320 may be an example of a configurable reflective device (e.g., a RIS entity).

As discussed, aspects of the described techniques may leverage the beam squint effect of the RIS 320 to support simultaneous multi-UE communications. For example, the network entity 315 may transmit or otherwise provide an array configuration to the RIS 320 that defines a first angle of reflection or refraction at a first frequency and a second angle of reflection or refraction at a second frequency. The reflection/refraction angles may be associated with a reflective array of the RIS 320. That is, the array configuration may generally configure the reflective array of the RIS 320 in a manner to support multiple transmissions at different frequencies being reflected or refracted in different directions such that the different UEs, located at different locations, can receive their respective transmission at their respective frequency.

Accordingly, the network entity 315 may transmit or otherwise provide a first transmission to a first UE (e.g., the UE 305, in this example) at a first frequency (e.g., f2, in this example) according to the array configuration. The first frequency may be identified or otherwise selected based on the first angle of reflection or refraction and the first location of the first UE (e.g., relative to the RIS 320). The network entity 315 may (e.g., simultaneously) transmit or otherwise provide a second transmission to the second UE (e.g., the UE 310, in this example) at a second frequency (e.g., f4, in this example) according to the array configuration. The second frequency may be identified or otherwise selected based on the second angle of reflection or refraction and the second location of the second UE (e.g., relative to the RIS 320).

Wireless communications system 300 illustrates one non-limiting example of techniques that may be employed to perform the simultaneous multi-UE transmissions via the RIS 320. That is, aspects of the described techniques may use joint receiver selection, frequency allocation, and RIS configuration designs for simultaneous frequency multiplexed transmissions between a transmitting device (e.g., the network entity 315, in this example) and multiple receiving devices (e.g., the UE 305 and the UE 310, in this example). This may include using the accurate or approximate transmitting device/receiving device location and direction information, when available. Wireless communications system 300 illustrates a non-limiting example of a mechanism in which the array configuration and subsequent transmissions may be identified, determined, or otherwise selected.

This may include the network entity 315 transmitting or otherwise providing for output a set of pilot transmissions via the network entity 315 using a set of available array configurations and at different frequencies. For example, the network entity 315 may output each array configuration in the set of available array configurations to the RIS 320 in an iterative fashion. During each iteration, the network entity 315 may transmit or otherwise provide for output the set of pilot transmissions using each available array configuration at the different frequencies. For example, the network entity 315 may beam sweep (e.g., using each beam 325 from a set of beams) at the network entity 315 by changing its element weights (e.g., RIS configurations), where each configuration may map to a reflected or refracted beam with a single peak. The peak (e.g., the pointing direction) of each beam may change with the observed frequency due to the squint effect.

More particularly, the network entity 315 may configure the RIS 320 with a first array configuration and then beam sweep transmissions towards the RIS 320 at each or some of the available operating frequencies (e.g., within a bandwidth or BWP). For the first array configuration, each pilot signal transmission may be at or associated with a different frequency that may result in a different angle of reflection or refraction of the pilot signal from the RIS 320. The network entity 315 may configure the RIS 320 with a second array configuration and then beam sweep transmissions towards the RIS 320 at different frequencies. For the second array configuration, each pilot transmission may again be at or associated with a different frequency that may result in a different angle of reflection or refraction of the pilot signal from the RIS 320. The network entity 315 may continue to (e.g., iteratively) change the RIS configuration and sweep the pilot signal transmissions towards the RIS 320 at different frequencies to determine the peak beam strength(s) and direction(s) for each frequency for each array configuration.

The network entity 315 may select the array configuration to be used for the simultaneous transmissions to multiple UEs based at least in part on feedback received from receiving devices available for wireless communications via the RIS 320. For example, the network entity 315 may receive or otherwise obtain a first feedback report from a first UE (e.g., the UE 305, in this example) based on the set of pilot transmissions. The first feedback report may carry or otherwise convey information associated with the array configuration, the first frequency, the first angle of reflection or refraction, or a first measurement value associated with the array configuration and the first frequency. In the non-limiting example shown in FIG. 3, the first frequency reported by the first UE (e.g., the UE 305, in this example) may correspond to f2.

Similarly, the network entity 315 may receive or otherwise obtain a second feedback report from a second UE (e.g., the UE 310, in this example) based on the set of pilot transmissions. The second feedback report may carry or otherwise convey information associated with the array configuration, the second frequency, the second angle of reflection or refraction, or a second measurement value associated with the array configuration and the second frequency. In the non-limiting example shown in FIG. 3, the second frequency reported by the second UE (e.g., the UE 310, in this example) may correspond to f4.

More particularly, this may include each receiving device (Rxᵢ) identifying and reporting a set of Mᵢ RIS configurations W₍ᵢ₎={Wᵢ^{q}}_{q=1}^{M}^{ᵢ} (or their associated indices) from the beam sweep of pilot signal transmissions. Each of these Mᵢ RIS configurations may enable the best communication performance between the transmitting device and the receiving device reporting the feedback at a certain frequency from a set of frequencies that are indicated to be observed by the receiving device (Rxᵢ). Each receiving device reporting the feedback to the network entity 315 may also report a set of accompanying measurement values. Each receiving device reporting the feedback to the network entity 315 may also report, in some instances, location or direction information associated with the reporting device.

The network entity 315 may determine, identify, or otherwise select the array configuration, the first and second frequencies, or the first and second angles of reflection or refraction based on the feedback reports received in response to the beam-swept pilot signal transmissions. The network entity 315 may select the first location of the first UE or the second location of the second UE based at least in part on the set of pilot transmissions, the first feedback report, or the second feedback report. Additionally, or alternatively, the network entity 315 may select the first frequency for the first transmission to the first UE or the second frequency for the second transmission to the second UE based at least in part on the set of pilot transmissions, the first feedback report or the second feedback report. Additionally, or alternatively, the network entity 315 may select the first angle of reflection or refraction at the first frequency or the second angle of reflection or refraction at the second frequency based at least in part on the set of pilot transmissions, the first feedback report, or the second feedback report.

For example, the select the overall RIS weight (W) (e.g., the array configuration) as a function of the obtained configuration sets (e.g., feedback reports) and, if available, the associated measurement reports or uncertainty regions according to w=f({w₁^{q}}_{q=1}^{M}^{₁}, {w₂^{q}}_{q=1}^{M}^{₂} . . . ). This may enable a simultaneous communication between the transmitting device and the chosen receiving devices at their respective assigned frequencies (e.g., within their operating frequency bands).

The set of RIS configurations to sweep at the RIS 320 may be designed based on the uncertainty regions of the transmitting device and the receiving devices and a candidate pool of frequencies. A default or baseline design may be used when this information is unavailable.

In some examples, a network node or entity may manage aspects of the array configuration selection or identification. For example, the network entity 315 may transmit or otherwise provide for output an indication of the feedback report(s) to the network node (e.g., a controlling network node). The network node may identify or otherwise determine the array configuration, the first or second frequencies, or the first or second angles of reflection or refraction based on the location of the receiving devices relative to the RIS 320. The network node may transmit or otherwise provide for output (and the network entity 315 may receive or otherwise obtain) an indication of the array configuration. For example, the controlling network node may construct a weight vector for the RIS 320 that is a function of the reported set of best RIS configurations from each receiving device (and measurement values or uncertainty regions, if available) and assign the frequency bands to a chosen subset of receiving devices.

Accordingly, wireless communications system 300 illustrates a non-limiting example of a system for simultaneous multi-layer (e.g., with more than one layer per polarization) communications between a transmitter and multiple receivers, enabled by the RIS 320, where the receivers can be assigned distinct frequencies (e.g., frequency bands). Some or all of the weight vectors or configurations (e.g., array configurations) may be applied sequentially at the RIS 320 where the transmitting device transmits pilot signals across multiple frequencies. The reflected or refracted signals may be measured at each receiving device at an indicated set of frequencies. Each receiving device may feed back reports indicating the best array configuration(s) for at least a subset of its indicated frequencies, with or without the corresponding measurement values. The RIS configurations that are sequentially applied may be constructed based on a candidate pool of frequencies or uncertainty regions for the transmitter and each receiver relative to the RIS 320, which may be provided by the network node (in some examples). The selected array configuration (e.g., weight vector) may enable the RIS 320 to perform as a mirror of different orientations across the different frequencies. This may be leveraged to schedule the multi-UE transmissions using the different per-frequency reflection/refraction angles at the corresponding different frequencies to reduce communications latency and increase throughput.

In some aspects, the RIS configuration may be held fixed while a sweep over the frequencies is conducted by the network entity 315 sequentially transmitting pilot signals in time and in different frequency bands. Each receiving device may measure the reflected or refracted signals at those frequency bands and report a message consisting of the indication of the best (or top M) frequency bands, with or without the corresponding measurement values, to the network entity 315.

In some aspects, the described techniques may support a use case for the RIS 320 to support frequency multiplexed communication between one transmitter and multiple receivers given the transmitter/receiver location/direction information and associated uncertainty. This may support exploiting beam squint via smart (user) receiver subset-selection and frequency assignment, which may avoid gain reductions due to widening of the reflected or refracted beam (or creating multiple lobes) if the natural beam squint can ensure proper beam pointing to chosen receivers on their assigned frequencies.

The described techniques may support a use case of wideband pilot transmissions (possibly across component carriers with carrier aggregation) with RIS 320 assisted communications to acquire the preferred beam and squint information. This may support a use case of narrowband pilot transmissions with frequency-sweep (possibly across component carriers with carrier aggregation) in RIS 320 assisted communications to acquire preferred beam and squint information. The described techniques may support a use case of exploiting a priori location/direction information for constructing a beam set used in the sweep, as well as combining with feedback reports from the beam sweep to construct an optimized RIS configuration.

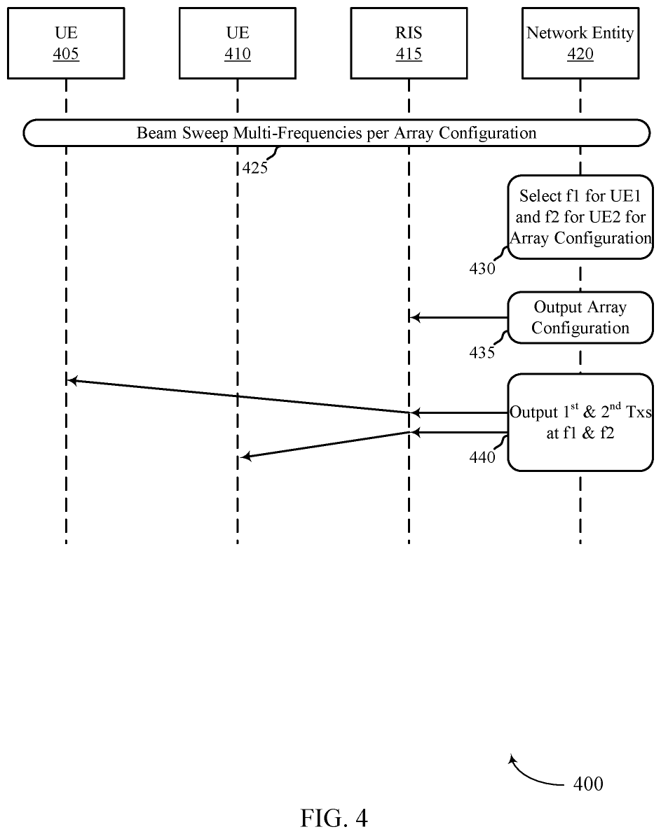

FIG. 4 shows an example of a swim diagram 400 that supports beam squint and location-uncertainty aware designs in accordance with one or more aspects of the present disclosure. Swim diagram may implement aspects of wireless communications system 100, wireless communications system 200, or wireless communications system 300. Aspects of swim diagram may be implemented at or implemented by a UE 405, a UE 410, a RIS 415, and a network entity 420, which may be examples of the corresponding devices or entities described herein. For example, the RIS 415 may be an example of a configurable reflective device (e.g., a RIS entity).

At 425, the UE 405, the UE 410, the RIS 415, and the network entity 420 may perform a beam sweep of pilot signal transmissions using multiple frequencies per array configuration. For example, this may be based on the set of pilot transmission features discussed with reference to wireless communications system 300 of FIG. 3.

At 430, the network entity 420 may identify or otherwise select the first frequency (e.g., f1) for the first UE (e.g., the UE 405 or UE1, in this example) and the second frequency (e.g., f2) for the second UE (e.g., the UE 410 or UE2, in this example). For example, the network entity 420 may identify the first frequency to use for a first transmission to the first UE based on the location of the first UE relative to the RIS 415 and identify the second frequency to use for a second transmission to the second UE based on the location of the second UE relative to the RIS 415. In some aspects, the first and second frequencies may be selected based on the beam sweep procedure.

Additionally, or alternatively, the network entity 420 may identify or otherwise select the first and second UE based on the location of each UE or based on the angle of reflection or refraction of each UE relative to the RIS 415.

At 435, the network entity 420 may transmit or otherwise provide for output (and the RIS 415 may receive or otherwise obtain) an array configuration. The array configuration may define or otherwise be based on a first angle of reflection or refraction at a first frequency to be used for the first transmission to the first UE and a second angle of reflection or refraction at a second frequency to be used for the second transmission to the second UE. For example, the array configuration may support the RIS 415 configured according to the array configuration to support simultaneous multi-UE transmissions at different frequencies using the squint effect.

At 440, the network entity 420 may transmit or otherwise provide for output a first transmission to the first UE (e.g., the UE 405) at the first frequency f1 and a second transmission to the second UE (e.g., the UE 410) at the second frequency f2. These transmissions may be provided to the UE via the RIS 415 where, based on the array configuration, the first transmission at f1 is reflected/refracted towards the first UE and the second transmission at f2 is reflected/refracted towards the second UE.

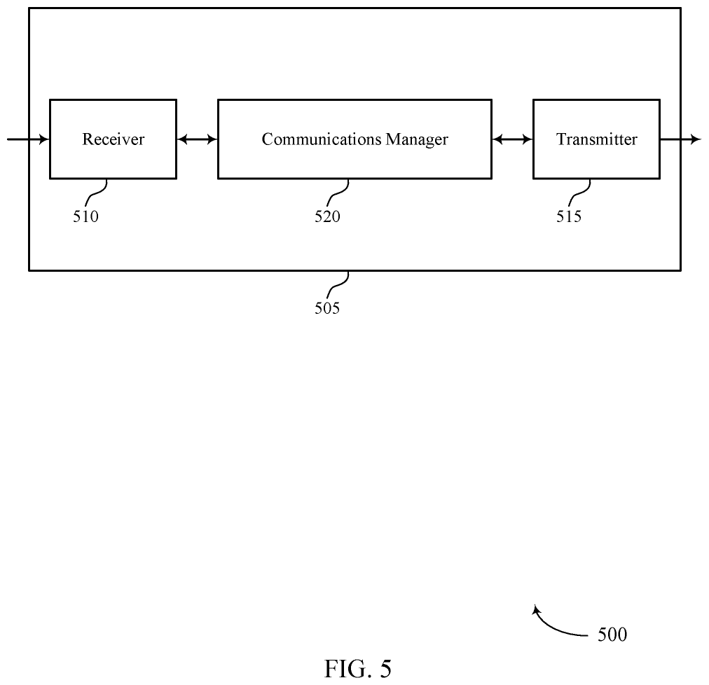

FIG. 5 shows a block diagram 500 of a device 505 that supports beam squint and location-uncertainty aware designs in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations thereof or various components thereof may be examples of means for performing various aspects of beam squint and location-uncertainty aware designs as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for outputting an array configuration to a configurable reflective device, where the array configuration defines a first angle of reflection or refraction at a first frequency and a second angle of reflection or refraction at a second frequency for a reflective array of the configurable reflective device. The communications manager 520 is capable of, configured to, or operable to support a means for outputting a first transmission, to a first UE via the configurable reflective device, at the first frequency according to the array configuration, the first frequency selected based on the first angle of reflection or refraction and a first location of the first UE. The communications manager 520 is capable of, configured to, or operable to support a means for outputting a second transmission, to a second UE via the configurable reflective device, at the second frequency according to the array configuration, the second frequency selected based on the second angle of reflection or refraction and a second location of the second UE.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for simultaneous multi-UE transmissions via a RIS at different frequencies that leverage the beam squint effect to bend the transmission towards disparately-located UE.

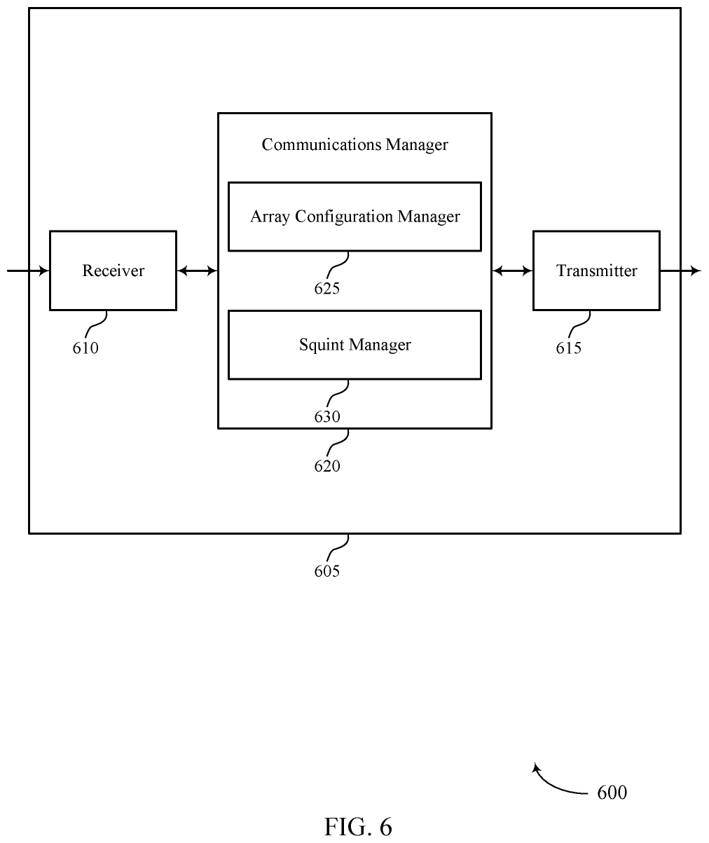

FIG. 6 shows a block diagram 600 of a device 605 that supports beam squint and location-uncertainty aware designs in accordance with one or more aspects of the present disclosure. The device 605 may be an example of aspects of a device 505 or a network entity 105 as described herein. The device 605 may include a receiver 610, a transmitter 615, and a communications manager 620. The device 605, or one of more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of beam squint and location-uncertainty aware designs as described herein. For example, the communications manager 620 may include an array configuration manager 625 a squint manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The array configuration manager 625 is capable of, configured to, or operable to support a means for outputting an array configuration to a configurable reflective device, where the array configuration defines a first angle of reflection or refraction at a first frequency and a second angle of reflection or refraction at a second frequency for a reflective array of the configurable reflective device. The squint manager 630 is capable of, configured to, or operable to support a means for outputting a first transmission, to a first UE via the configurable reflective device, at the first frequency according to the array configuration, the first frequency selected based on the first angle of reflection or refraction and a first location of the first UE. The squint manager 630 is capable of, configured to, or operable to support a means for outputting a second transmission, to a second UE via the configurable reflective device, at the second frequency according to the array configuration, the second frequency selected based on the second angle of reflection or refraction and a second location of the second UE.

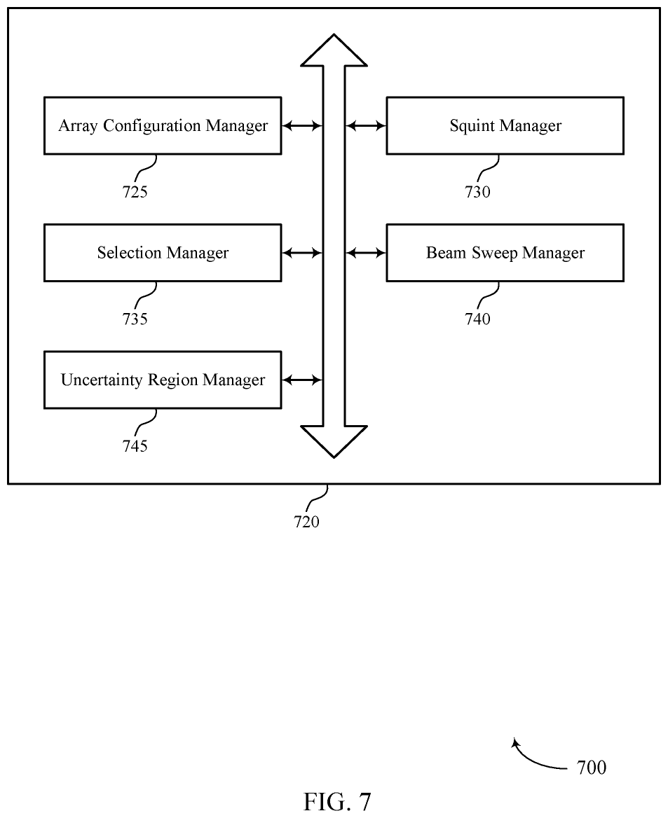

FIG. 7 shows a block diagram 700 of a communications manager 720 that supports beam squint and location-uncertainty aware designs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of beam squint and location-uncertainty aware designs as described herein. For example, the communications manager 720 may include an array configuration manager 725, a squint manager 730, a selection manager 735, a beam sweep manager 740, an uncertainty region manager 745, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The array configuration manager 725 is capable of, configured to, or operable to support a means for outputting an array configuration to a configurable reflective device, where the array configuration defines a first angle of reflection or refraction at a first frequency and a second angle of reflection or refraction at a second frequency for a reflective array of the configurable reflective device. The squint manager 730 is capable of, configured to, or operable to support a means for outputting a first transmission, to a first UE via the configurable reflective device, at the first frequency according to the array configuration, the first frequency selected based on the first angle of reflection or refraction and a first location of the first UE. In some examples, the squint manager 730 is capable of, configured to, or operable to support a means for outputting a second transmission, to a second UE via the configurable reflective device, at the second frequency according to the array configuration, the second frequency selected based on the second angle of reflection or refraction and a second location of the second UE.

In some examples, the selection manager 735 is capable of, configured to, or operable to support a means for selecting the first UE for communicating the first transmission at the first frequency based on the first location of the first UE relative to the configurable reflective device. In some examples, the selection manager 735 is capable of, configured to, or operable to support a means for selecting the second UE for communicating the second transmission at the second frequency based on the second location of the second UE relative to the configurable reflective device.

In some examples, the selection manager 735 is capable of, configured to, or operable to support a means for selecting the first UE for communicating the first transmission at the first frequency based on the first angle of reflection or refraction of the first UE relative to the configurable reflective device. In some examples, the selection manager 735 is capable of, configured to, or operable to support a means for selecting the second UE for communicating the second transmission at the second frequency based on the second angle of reflection or refraction of the second UE relative to the configurable reflective device.

In some examples, the selection manager 735 is capable of, configured to, or operable to support a means for selecting the first frequency for communicating the first transmission to the first UE based on the first location of the first UE relative to the configurable reflective device. In some examples, the selection manager 735 is capable of, configured to, or operable to support a means for selecting the second frequency for communicating the second transmission to the second UE based on the second location of the second UE relative to the configurable reflective device.

In some examples, the selection manager 735 is capable of, configured to, or operable to support a means for selecting the array configuration based on the first location of the first UE relative to the configurable reflective device, on the first angle of reflection or refraction, on the second location of the second UE relative to the configurable reflective device, on the second angle of reflection or refraction, or any combination thereof.

In some examples, the beam sweep manager 740 is capable of, configured to, or operable to support a means for performing a set of pilot transmissions via the configurable reflective device using a set of available array configurations and at different frequencies. In some examples, the beam sweep manager 740 is capable of, configured to, or operable to support a means for obtaining, based on the set of pilot transmissions, a first feedback report from the first UE indicating the array configuration, the first frequency, the first angle of reflection or refraction, a first measurement value associated with the array configuration and the first frequency, or any combination thereof. In some examples, the beam sweep manager 740 is capable of, configured to, or operable to support a means for obtaining, based on the set of pilot transmissions, a second feedback report from the second UE indicating the array configuration, the second frequency, the second angle of reflection angle, a second measurement value associated with the array configuration and the second frequency, or any combination thereof.

In some examples, to support performing the set of pilot transmissions, the beam sweep manager 740 is capable of, configured to, or operable to support a means for outputting, iteratively for each available array configuration in the set of available array configurations, each available array configuration in the set of available array configurations. In some examples, to support performing the set of pilot transmissions, the beam sweep manager 740 is capable of, configured to, or operable to support a means for outputting, during each iteration, the set of pilot transmissions using each available array configuration at the different frequencies.

In some examples, the beam sweep manager 740 is capable of, configured to, or operable to support a means for outputting an indication of the first feedback report, the second feedback report, or both. In some examples, the beam sweep manager 740 is capable of, configured to, or operable to support a means for obtaining, based on the indication, an indication of the array configuration based on the first feedback report, the second feedback report, and a location of the configurable reflective device relative to the first UE and the second UE.

In some examples, selection of the first location of the first UE, the second location of the second UE, or both, are based on the set of pilot transmissions, the first feedback report, the second feedback report, or any combination thereof. In some examples, selection of the first frequency for the first transmission to the first UE, the second frequency for the second transmission to the second UE, or both, are based on the set of pilot transmissions, the first feedback report, the second feedback report, or any combination thereof. In some examples, selection the first angle of reflection or refraction at the first frequency, the second angle of reflection or refraction at the second frequency, or both, are based on the set of pilot transmissions, the first feedback report, the second feedback report, or any combination thereof.

In some examples, the uncertainty region manager 745 is capable of, configured to, or operable to support a means for obtaining information associated with a first uncertainty region associated with the first location of the first UE and a second uncertainty region associated with the second location of the second UE. In some examples, selection of the first UE, the first frequency, the second UE, the second frequency, or any combination thereof, is based on the first uncertainty region, the second uncertainty region, or both. In some examples, selection of the array configuration is based on the first uncertainty region, the second uncertainty region, or both. In some examples, the first transmission to the first UE and the second transmission to the second UE include overlapping transmissions in a time domain.

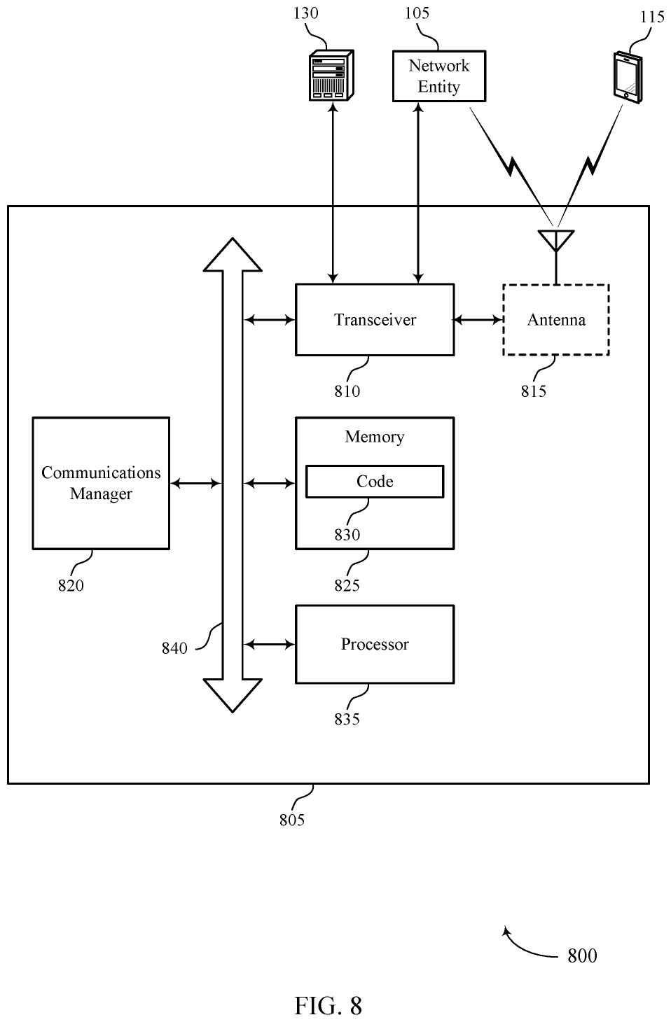

FIG. 8 shows a diagram of a system 800 including a device 805 that supports beam squint and location-uncertainty aware designs in accordance with one or more aspects of the present disclosure. The device 805 may be an example of or include the components of a device 505, a device 605, or a network entity 105 as described herein. The device 805 may communicate with one or more network entities 105, one or more UEs 115, or any combination thereof, which may include communications over one or more wired interfaces, over one or more wireless interfaces, or any combination thereof. The device 805 may include components that support outputting and obtaining communications, such as a communications manager 820, a transceiver 810, an antenna 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., a communication link 125, a backhaul communication link 120, a midhaul communication link 162, a fronthaul communication link 168).

The at least one memory 825 may include RAM, ROM, or any combination thereof. The at least one memory 825 may store computer-readable, computer-executable code 830 including instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may contain, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting beam squint and location-uncertainty aware designs). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825). In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with other network entities 105, and may include a controller or scheduler for controlling communications with UEs 115 in cooperation with other network entities 105. In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for outputting an array configuration to a configurable reflective device, where the array configuration defines a first angle of reflection or refraction at a first frequency and a second angle of reflection or refraction at a second frequency for a reflective array of the configurable reflective device. The communications manager 820 is capable of, configured to, or operable to support a means for outputting a first transmission, to a first UE via the configurable reflective device, at the first frequency according to the array configuration, the first frequency selected based on the first angle of reflection or refraction and a first location of the first UE. The communications manager 820 is capable of, configured to, or operable to support a means for outputting a second transmission, to a second UE via the configurable reflective device, at the second frequency according to the array configuration, the second frequency selected based on the second angle of reflection or refraction and a second location of the second UE.

By including or configuring the communications manager 820 in accordance with examples as described herein, the device 805 may support techniques for simultaneous multi-UE transmissions via a RIS at different frequencies that leverage the beam squint effect to bend the transmission towards disparately-located UE.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of beam squint and location-uncertainty aware designs as described herein, or the at least one processor 835 and the at least one memory 825 may be otherwise configured to, individually or collectively, perform or support such operations.

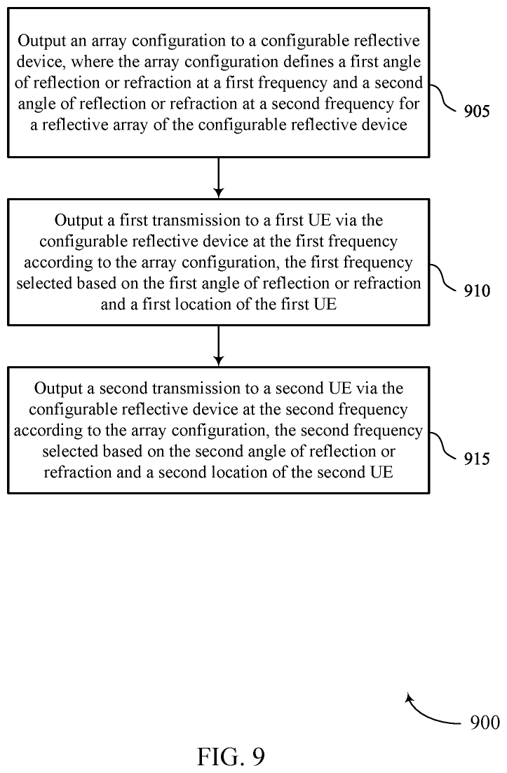

FIG. 9 shows a flowchart illustrating a method 900 that supports beam squint and location-uncertainty aware designs in accordance with one or more aspects of the present disclosure. The operations of the method 900 may be implemented by a network entity or its components as described herein. For example, the operations of the method 900 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 905, the method may include outputting an array configuration to a configurable reflective device, where the array configuration defines a first angle of reflection or refraction at a first frequency and a second angle of reflection or refraction at a second frequency for a reflective array of the configurable reflective device. The operations of block 905 may be performed in accordance with examples as disclosed herein, such as the transmission of the array configuration at 435 of FIG. 4. The array configuration may define the first and second angles of reflection/refraction at the first and second frequencies, respectively. In some examples, aspects of the operations of 905 may be performed by an array configuration manager 725 as described with reference to FIG. 7.

At 910, the method may include outputting a first transmission to a first UE via the configurable reflective device at the first frequency according to the array configuration. The first frequency may be selected based on the first angle of reflection or refraction and a first location of the first UE. The operations of block 910 may be performed in accordance with examples as disclosed herein, such as the first transmission at 440 of FIG. 4. The first frequency or first UE selected for the first transmission may be based on the first angle of reflection or refraction for the array configuration. In some examples, aspects of the operations of 910 may be performed by a squint manager 730 as described with reference to FIG. 7.

At 915, the method may include outputting a second transmission to a second UE via the configurable reflective device at the second frequency according to the array configuration. The second frequency may be selected based on the second angle of reflection or refraction and a second location of the second UE. The operations of block 915 may be performed in accordance with examples as disclosed herein, such as the first transmission at 440 of FIG. 4. The first frequency or first UE selected for the first transmission may be based on the first angle of reflection or refraction for the array configuration. In some examples, aspects of the operations of 915 may be performed by a squint manager 730 as described with reference to FIG. 7.

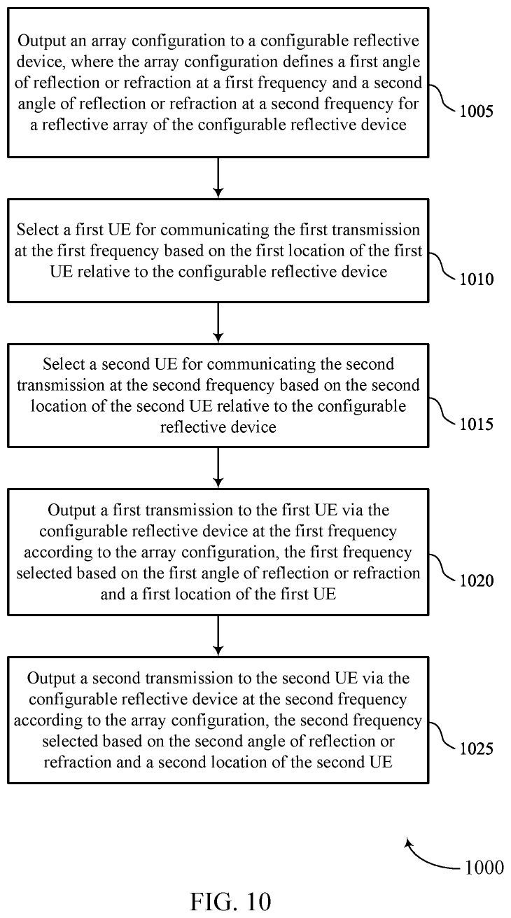

FIG. 10 shows a flowchart illustrating a method 1000 that supports beam squint and location-uncertainty aware designs in accordance with one or more aspects of the present disclosure. The operations of the method 1000 may be implemented by a network entity or its components as described herein. For example, the operations of the method 1000 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1005, the method may include outputting an array configuration to a configurable reflective device, where the array configuration defines a first angle of reflection or refraction at a first frequency and a second angle of reflection or refraction at a second frequency for a reflective array of the configurable reflective device. The operations of block 1005 may be performed in accordance with examples as disclosed herein, such as the transmission of the array configuration at 435 of FIG. 4. The array configuration may define the first and second angles of reflection/refraction at the first and second frequencies, respectively. In some examples, aspects of the operations of 1005 may be performed by an array configuration manager 725 as described with reference to FIG. 7.

At 1010, the method may include selecting a first UE for communicating the first transmission at the first frequency based on the first location of the first UE relative to the configurable reflective device. The operations of block 1010 may be performed in accordance with examples as disclosed herein, such as selection of the first UE at 430 of FIG. 4. The first UE selected for the first transmission may be based on the first angle of reflection or refraction for the array configuration at the first frequency. In some examples, aspects of the operations of 1010 may be performed by a selection manager 735 as described with reference to FIG. 7.

At 1015, the method may include selecting a second UE for communicating the second transmission at the second frequency based on the second location of the second UE relative to the configurable reflective device. The operations of block 1015 may be performed in accordance with examples as disclosed herein, such as selection of the second UE at 430 of FIG. 4. The second UE selected for the second transmission may be based on the second angle of reflection or refraction for the array configuration at the second frequency. In some examples, aspects of the operations of 1015 may be performed by a selection manager 735 as described with reference to FIG. 7.

At 1020, the method may include outputting a first transmission, to the first UE via the configurable reflective device, at the first frequency according to the array configuration. The first frequency may be selected based on the first angle of reflection or refraction and a first location of the first UE. The operations of block 1020 may be performed in accordance with examples as disclosed herein, such as the first transmission at 440 of FIG. 4. The first frequency or first UE selected for the first transmission may be based on the first angle of reflection or refraction for the array configuration. In some examples, aspects of the operations of 1020 may be performed by a squint manager 730 as described with reference to FIG. 7.

At 1025, the method may include outputting a second transmission, to the second UE via the configurable reflective device, at the second frequency according to the array configuration. The second frequency may be selected based on the second angle of reflection or refraction and a second location of the second UE. The operations of block 1025 may be performed in accordance with examples as disclosed herein, such as the first transmission at 440 of FIG. 4. The first frequency or first UE selected for the first transmission may be based on the first angle of reflection or refraction for the array configuration. In some examples, aspects of the operations of 1025 may be performed by a squint manager 730 as described with reference to FIG. 7.

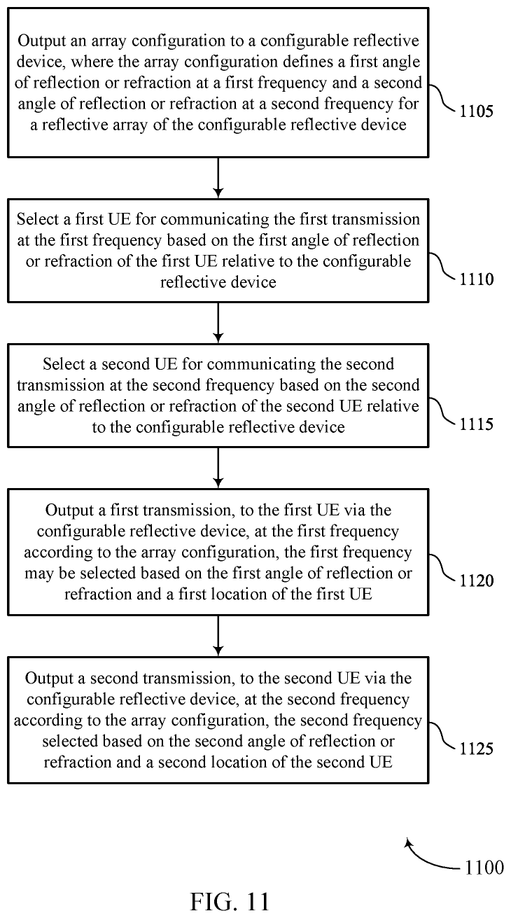

FIG. 11 shows a flowchart illustrating a method 1100 that supports beam squint and location-uncertainty aware designs in accordance with one or more aspects of the present disclosure. The operations of the method 1100 may be implemented by a network entity or its components as described herein. For example, the operations of the method 1100 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1105, the method may include outputting an array configuration to a configurable reflective device, where the array configuration defines a first angle of reflection or refraction at a first frequency and a second angle of reflection or refraction at a second frequency for a reflective array of the configurable reflective device. The operations of block 1105 may be performed in accordance with examples as disclosed herein, such as the transmission of the array configuration at 435 of FIG. 4. The array configuration may define the first and second angles of reflection/refraction at the first and second frequencies, respectively. In some examples, aspects of the operations of 1105 may be performed by an array configuration manager 725 as described with reference to FIG. 7.

At 1110, the method may include selecting a first UE for communicating the first transmission at the first frequency based on the first angle of reflection or refraction of the first UE relative to the configurable reflective device. The operations of block 1110 may be performed in accordance with examples as disclosed herein, such as selection of the first UE at 430 of FIG. 4. The first UE selected for the first transmission may be based on the first angle of reflection or refraction for the array configuration relative to the RIS. In some examples, aspects of the operations of 1110 may be performed by a selection manager 735 as described with reference to FIG. 7.

At 1115, the method may include selecting a second UE for communicating the second transmission at the second frequency based on the second angle of reflection or refraction of the second UE relative to the configurable reflective device. The operations of block 1115 may be performed in accordance with examples as disclosed herein, such as selection of the first UE at 430 of FIG. 4. The second UE selected for the second transmission may be based on the second angle of reflection or refraction for the array configuration relative to the RIS. In some examples, aspects of the operations of 1115 may be performed by a selection manager 735 as described with reference to FIG. 7.

At 1120, the method may include outputting a first transmission, to the first UE via the configurable reflective device, at the first frequency according to the array configuration. The first frequency may be selected based on the first angle of reflection or refraction and a first location of the first UE. The operations of block 1120 may be performed in accordance with examples as disclosed herein, such as the first transmission at 440 of FIG. 4. The first frequency or first UE selected for the first transmission may be based on the first angle of reflection or refraction for the array configuration. In some examples, aspects of the operations of 1120 may be performed by a squint manager 730 as described with reference to FIG. 7.

At 1125, the method may include outputting a second transmission, to the second UE via the configurable reflective device, at the second frequency according to the array configuration. The second frequency may be selected based on the second angle of reflection or refraction and a second location of the second UE. The operations of block 1125 may be performed in accordance with examples as disclosed herein, such as the first transmission at 440 of FIG. 4. The first frequency or first UE selected for the first transmission may be based on the first angle of reflection or refraction for the array configuration. In some examples, aspects of the operations of 1125 may be performed by a squint manager 730 as described with reference to FIG. 7.

The following provides an overview of aspects of the present disclosure:

Aspect 1: A method for wireless communications at a network entity, comprising: outputting an array configuration to a configurable reflective device, wherein the array configuration defines a first angle of reflection or refraction at a first frequency and a second angle of reflection or refraction at a second frequency for a reflective array of the configurable reflective device; outputting a first transmission, to a first UE via the configurable reflective device, at the first frequency according to the array configuration, the first frequency selected based at least in part on the first angle of reflection or refraction and a first location of the first UE; and outputting a second transmission, to a second UE via the configurable reflective device, at the second frequency according to the array configuration, the second frequency selected based at least in part on the second angle of reflection or refraction and a second location of the second UE.

Aspect 2: The method of aspect 1, further comprising: selecting the first UE for communicating the first transmission at the first frequency based at least in part on the first location of the first UE relative to the configurable reflective device; and selecting the second UE for communicating the second transmission at the second frequency based at least in part on the second location of the second UE relative to the configurable reflective device.

Aspect 3: The method of any of aspects 1 through 2, further comprising: selecting the first UE for communicating the first transmission at the first frequency based at least in part on the first angle of reflection or refraction of the first UE relative to the configurable reflective device; and selecting the second UE for communicating the second transmission at the second frequency based at least in part on the second angle of reflection or refraction of the second UE relative to the configurable reflective device.

Aspect 4: The method of any of aspects 1 through 3, further comprising: selecting the first frequency for communicating the first transmission to the first UE based at least in part on the first location of the first UE relative to the configurable reflective device; and selecting the second frequency for communicating the second transmission to the second UE based at least in part on the second location of the second UE relative to the configurable reflective device.

Aspect 5: The method of any of aspects 1 through 4, further comprising: selecting the array configuration based at least in part on the first location of the first UE relative to the configurable reflective device, on the first angle of reflection or refraction, on the second location of the second UE relative to the configurable reflective device, on the second angle of reflection or refraction, or any combination thereof.

Aspect 6: The method of any of aspects 1 through 5, further comprising: performing a set of pilot transmissions via the configurable reflective device using a set of available array configurations and at different frequencies; obtaining, based on the set of pilot transmissions, a first feedback report from the first UE indicating the array configuration, the first frequency, the first angle of reflection or refraction, a first measurement value associated with the array configuration and the first frequency, or any combination thereof; and obtaining, based on the set of pilot transmissions, a second feedback report from the second UE indicating the array configuration, the second frequency, the second angle of reflection angle, a second measurement value associated with the array configuration and the second frequency, or any combination thereof.

Aspect 7: The method of aspect 6, wherein performing the set of pilot transmissions comprises: outputting, iteratively for each available array configuration in the set of available array configurations, each available array configuration in the set of available array configurations; and outputting, during each iteration, the set of pilot transmissions using each available array configuration at the different frequencies.

Aspect 8: The method of any of aspects 6 through 7, further comprising: outputting an indication of the first feedback report, the second feedback report, or both; and obtaining, based on the indication, an indication of the array configuration based at least in part on the first feedback report, the second feedback report, and a location of the configurable reflective device relative to the first UE and the second UE.

Aspect 9: The method of any of aspects 6 through 8, wherein selection of the first location of the first UE, the second location of the second UE, or both, are based at least in part on the set of pilot transmissions, the first feedback report, the second feedback report, or any combination thereof.

Aspect 10: The method of any of aspects 6 through 9, wherein selection of the first frequency for the first transmission to the first UE, the second frequency for the second transmission to the second UE, or both, are based at least in part on the set of pilot transmissions, the first feedback report, the second feedback report, or any combination thereof.

Aspect 11: The method of any of aspects 6 through 10, wherein selection the first angle of reflection or refraction at the first frequency, the second angle of reflection or refraction at the second frequency, or both, are based at least in part on the set of pilot transmissions, the first feedback report, the second feedback report, or any combination thereof.

Aspect 12: The method of any of aspects 1 through 11, further comprising: obtaining information associated with a first uncertainty region associated with the first location of the first UE and a second uncertainty region associated with the second location of the second UE.

Aspect 13: The method of aspect 12, wherein selection of the first UE, the first frequency, the second UE, the second frequency, or any combination thereof, is based at least in part on the first uncertainty region, the second uncertainty region, or both.

Aspect 14: The method of any of aspects 12 through 13, wherein selection of the array configuration is based at least in part on the first uncertainty region, the second uncertainty region, or both.

Aspect 15: The method of any of aspects 1 through 14, wherein the first transmission to the first UE and the second transmission to the second UE comprise overlapping transmissions in a time domain.

Aspect 16: A network entity for wireless communications, comprising one or more memories storing processor-executable code, and one or more processors coupled with the one or more memories and individually or collectively operable to execute the code to cause the network entity to perform a method of any of aspects 1 through 15.

Aspect 17: A network entity for wireless communications, comprising at least one means for performing a method of any of aspects 1 through 15.

Aspect 18: A non-transitory computer-readable medium storing code for wireless communications, the code comprising instructions executable by one or more processors to perform a method of any of aspects 1 through 15.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more processors;
one or more memories coupled with the one or more processors; and
one or more processor-readable instructions stored in the one or more memories and executable by the one or more processors to individually or collectively cause the network entity to:
output an array configuration to a configurable reflective device, wherein the array configuration defines a first angle of reflection or refraction at a first frequency and a second angle of reflection or refraction at a second frequency for a reflective array of the configurable reflective device;
output a first transmission, to a first user equipment (UE) via the configurable reflective device, at the first frequency according to the array configuration, the first frequency selected based at least in part on the first angle of reflection or refraction and a first location of the first UE; and
output a second transmission, to a second UE via the configurable reflective device, at the second frequency according to the array configuration, the second frequency selected based at least in part on the second angle of reflection or refraction and a second location of the second UE.

2. The network entity of claim 1, wherein the one or more processor-readable instructions are further executable by the one or more processors to individually or collectively cause the network entity to:
select the first UE for communicating the first transmission at the first frequency based at least in part on the first location of the first UE relative to the configurable reflective device; and
select the second UE for communicating the second transmission at the second frequency based at least in part on the second location of the second UE relative to the configurable reflective device.

3. The network entity of claim 1, wherein the one or more processor-readable instructions are further executable by the one or more processors to individually or collectively cause the network entity to:
select the first UE for communicating the first transmission at the first frequency based at least in part on the first angle of reflection or refraction of the first UE relative to the configurable reflective device; and
select the second UE for communicating the second transmission at the second frequency based at least in part on the second angle of reflection or refraction of the second UE relative to the configurable reflective device.

4. The network entity of claim 1, wherein the one or more processor-readable instructions are further executable by the one or more processors to individually or collectively cause the network entity to:
select the first frequency for communicating the first transmission to the first UE based at least in part on the first location of the first UE relative to the configurable reflective device; and
select the second frequency for communicating the second transmission to the second UE based at least in part on the second location of the second UE relative to the configurable reflective device.

5. The network entity of claim 1, wherein the one or more processor-readable instructions are further executable by the one or more processors to individually or collectively cause the network entity to:
select the array configuration based at least in part on the first location of the first UE relative to the configurable reflective device, on the first angle of reflection or refraction, on the second location of the second UE relative to the configurable reflective device, on the second angle of reflection or refraction, or any combination thereof.

6. The network entity of claim 1, wherein the one or more processor-readable instructions are further executable by the one or more processors to individually or collectively cause the network entity to:
perform a set of pilot transmissions via the configurable reflective device using a set of available array configurations and at different frequencies;
obtain, based on the set of pilot transmissions, a first feedback report from the first UE indicating the array configuration, the first frequency, the first angle of reflection or refraction, a first measurement value associated with the array configuration and the first frequency, or any combination thereof; and
obtain, based on the set of pilot transmissions, a second feedback report from the second UE indicating the array configuration, the second frequency, the second angle of reflection angle, a second measurement value associated with the array configuration and the second frequency, or any combination thereof.

7. The network entity of claim 6, wherein, to perform the set of pilot transmissions, the one or more processor-readable instructions are further executable by the one or more processors to individually or collectively cause the network entity to:
output, iteratively for each available array configuration in the set of available array configurations, each available array configuration in the set of available array configurations; and
output, during each iteration, the set of pilot transmissions using each available array configuration at the different frequencies.

8. The network entity of claim 6, wherein the one or more processor-readable instructions are further executable by the one or more processors to individually or collectively cause the network entity to:
output an indication of the first feedback report, the second feedback report, or both; and
obtain, based on the indication, an indication of the array configuration based at least in part on the first feedback report, the second feedback report, and a location of the configurable reflective device relative to the first UE and the second UE.

9. The network entity of claim 6, wherein selection of the first location of the first UE, the second location of the second UE, or both, are based at least in part on the set of pilot transmissions, the first feedback report, the second feedback report, or any combination thereof.

10. The network entity of claim 6, wherein selection of the first frequency for the first transmission to the first UE, the second frequency for the second transmission to the second UE, or both, are based at least in part on the set of pilot transmissions, the first feedback report, the second feedback report, or any combination thereof.

11. The network entity of claim 6, wherein selection the first angle of reflection or refraction at the first frequency, the second angle of reflection or refraction at the second frequency, or both, are based at least in part on the set of pilot transmissions, the first feedback report, the second feedback report, or any combination thereof.

12. The network entity of claim 1, wherein the one or more processor-readable instructions are further executable by the one or more processors to individually or collectively cause the network entity to:
obtain information associated with a first uncertainty region associated with the first location of the first UE and a second uncertainty region associated with the second location of the second UE.

13. The network entity of claim 12, wherein selection of the first UE, the first frequency, the second UE, the second frequency, or any combination thereof, is based at least in part on the first uncertainty region, the second uncertainty region, or both.

14. The network entity of claim 12, wherein selection of the array configuration is based at least in part on the first uncertainty region, the second uncertainty region, or both.

15. The network entity of claim 1, wherein the first transmission to the first UE and the second transmission to the second UE comprise overlapping transmissions in a time domain.

16. A method for wireless communications at a network entity, comprising:
outputting an array configuration to a configurable reflective device, wherein the array configuration defines a first angle of reflection or refraction at a first frequency and a second angle of reflection or refraction at a second frequency for a reflective array of the configurable reflective device;
outputting a first transmission, to a first user equipment (UE) via the configurable reflective device, at the first frequency according to the array configuration, the first frequency selected based at least in part on the first angle of reflection or refraction and a first location of the first UE; and
outputting a second transmission, to a second UE via the configurable reflective device, at the second frequency according to the array configuration, the second frequency selected based at least in part on the second angle of reflection or refraction and a second location of the second UE.

17. The method of claim 16, further comprising:
selecting the first UE for communicating the first transmission at the first frequency based at least in part on the first location of the first UE relative to the configurable reflective device; and
selecting the second UE for communicating the second transmission at the second frequency based at least in part on the second location of the second UE relative to the configurable reflective device.

18. The method of claim 16, further comprising:
selecting the first UE for communicating the first transmission at the first frequency based at least in part on the first angle of reflection or refraction of the first UE relative to the configurable reflective device; and
selecting the second UE for communicating the second transmission at the second frequency based at least in part on the second angle of reflection or refraction of the second UE relative to the configurable reflective device.

19. The method of claim 16, further comprising:
selecting the first frequency for communicating the first transmission to the first UE based at least in part on the first location of the first UE relative to the configurable reflective device; and
selecting the second frequency for communicating the second transmission to the second UE based at least in part on the second location of the second UE relative to the configurable reflective device.

20. The method of claim 16, further comprising:
selecting the array configuration based at least in part on the first location of the first UE relative to the configurable reflective device, on the first angle of reflection or refraction, on the second location of the second UE relative to the configurable reflective device, on the second angle of reflection or refraction, or any combination thereof.

21. The method of claim 16, further comprising:
performing a set of pilot transmissions via the configurable reflective device using a set of available array configurations and at different frequencies;
obtaining, based on the set of pilot transmissions, a first feedback report from the first UE indicating the array configuration, the first frequency, the first angle of reflection or refraction, a first measurement value associated with the array configuration and the first frequency, or any combination thereof; and
obtaining, based on the set of pilot transmissions, a second feedback report from the second UE indicating the array configuration, the second frequency, the second angle of reflection angle, a second measurement value associated with the array configuration and the second frequency, or any combination thereof.

22. The method of claim 21, wherein performing the set of pilot transmissions comprises:
outputting, iteratively for each available array configuration in the set of available array configurations, each available array configuration in the set of available array configurations; and
outputting, during each iteration, the set of pilot transmissions using each available array configuration at the different frequencies.

23. The method of claim 21, further comprising:
outputting an indication of the first feedback report, the second feedback report, or both; and
obtaining, based on the indication, an indication of the array configuration based at least in part on the first feedback report, the second feedback report, and a location of the configurable reflective device relative to the first UE and the second UE.

24. The method of claim 21, wherein selection of the first location of the first UE, the second location of the second UE, or both, are based at least in part on the set of pilot transmissions, the first feedback report, the second feedback report, or any combination thereof.

25. The method of claim 21, wherein selection of the first frequency for the first transmission to the first UE, the second frequency for the second transmission to the second UE, or both, are based at least in part on the set of pilot transmissions, the first feedback report, the second feedback report, or any combination thereof.

26. The method of claim 21, wherein selection the first angle of reflection or refraction at the first frequency, the second angle of reflection or refraction at the second frequency, or both, are based at least in part on the set of pilot transmissions, the first feedback report, the second feedback report, or any combination thereof.

27. The method of claim 16, further comprising:
obtaining information associated with a first uncertainty region associated with the first location of the first UE and a second uncertainty region associated with the second location of the second UE.

28. The method of claim 27, wherein selection of the first UE, the first frequency, the second UE, the second frequency, or any combination thereof, is based at least in part on the first uncertainty region, the second uncertainty region, or both.

29. A network entity for wireless communications, comprising:
means for outputting an array configuration to a configurable reflective device, wherein the array configuration defines a first angle of reflection or refraction at a first frequency and a second angle of reflection or refraction at a second frequency for a reflective array of the configurable reflective device;
means for outputting a first transmission, to a first user equipment (UE) via the configurable reflective device, at the first frequency according to the array configuration, the first frequency selected based at least in part on the first angle of reflection or refraction and a first location of the first UE; and
means for outputting a second transmission, to a second UE via the configurable reflective device, at the second frequency according to the array configuration, the second frequency selected based at least in part on the second angle of reflection or refraction and a second location of the second UE.

30. A non-transitory computer-readable medium storing code for wireless communications, the code comprising instructions executable by one or more processors to:
output an array configuration to a configurable reflective device, wherein the array configuration defines a first angle of reflection or refraction at a first frequency and a second angle of reflection or refraction at a second frequency for a reflective array of the configurable reflective device;
output a first transmission, to a first user equipment (UE) via the configurable reflective device, at the first frequency according to the array configuration, the first frequency selected based at least in part on the first angle of reflection or refraction and a first location of the first UE; and
output a second transmission, to a second UE via the configurable reflective device, at the second frequency according to the array configuration, the second frequency selected based at least in part on the second angle of reflection or refraction and a second location of the second UE.
